(19) United States
(12) Patent Application Publication
(10) Pub. No.: US 2008/0248201 A1
(43) Pub. Date: Oct. 9, 2008

(54) POLYMERIC COATINGS INCLUDING NANOPARTICLE FILLER

(75) Inventors: Robert W. Corkery, Stockholm (SE); Cathy Fleischer, Rochester, NY (US)

Correspondence Address: BASCH & NICKERSON LLP, 1777 PENFIELD ROAD, PENFIELD, NY, 14526, US

(73) Assignee: NaturalNano Research, Inc., Pittsford, NY (US)

(21) Appl. No.: 11/697,510

(22) Filed: Apr. 6, 2007

(51) Int. Cl. C08L 101/12; B05D 1/00

(52) U.S. Cl. 427/256; 427/373; 524/1; 524/445

(57) ABSTRACT

Disclosed is a novel polymeric composite coating including a nanoparticle filler, where the filler may be suitable to alter one or more characteristics of the coating. More particularly, one embodiment of the present invention provides a novel halloysite nanoparticle filler which has the general configuration of a cylinder or a rolled scroll-like shape, and a polymer protective coating containing the halloysite nanoparticle or equivalent nanotubular filler.

### CROSS-REFERENCE TO RELATED APPLICATION

U.S. patent application Ser. No. ______, for “IMPROVED POLYMERIC ADHESIVE INCLUDING NANOPARTICLE FILLER,” by R. Corkery et al., filed concurrently herewith, is cross-referenced and hereby incorporated by reference in its entirety.

The present invention relates to a novel polymeric coating including a nanoparticle filler, where the filler may be suitable to alter one or more characteristics of the coating. More particularly, one embodiment of the present invention provides a novel halloysite nanoparticle filler which has the general configuration of a cylinder, tube or a rolled scroll-like shape, in which the diameter of the cylinder is less than about 500 nm, and a polymer protective coating composite, containing the halloysite nanoparticle or other equivalent nanotubular filler, in which the advantages of the nanoparticle filler are provided (e.g., reinforcement, flame retardant, etc.) with equivalent or improved, mechanical performance of the protective coating composite (e.g., hardness, abrasion resistance, etc.).

### BACKGROUND AND SUMMARY

Polymeric coatings are commonly used in man-made materials for construction (sealants, paints), consumer products, automotive coatings, and the like. Filler particles may be introduced into such coatings, and are often utilized to control mechanical, thermal, optical, friction, and/or other physical properties. A polymer protective composite coating includes at least one polymer matrix or material in combination with at least one particulate filler material. The polymer matrix material may be any of a number of polymers including thermoplastics such as polyethylenes, polypropylenes, polyurethanes, vinyl polymers, and the like, thermosets, and elastomers. Also included in the range of polymers that may be used are biopolymers, including polysaccharides (e.g. starch), polypeptides and proteins such as caseins, gelatin, collagens, mucins, wheat gluten, etc. Some of the most common nanoparticle fillers are nanoclays, carbon nanotubes, and metal oxide nanoparticles such as Zinc Oxide (ZnO), Titanium Dioxide (Ti02), and Zirconia (ZrO). Today, polymer composite coating materials can be found in various products such as automobiles, building materials, household products, high performance fabrics, and food packaging. In many situations the composite coatings are protective coatings, which further offer the potential of materials having properties that are not often available in naturally occurring raw materials, such as mechanical strength, hardness, abrasion resistance, thermal resistance, lubrication and friction control, and the like.

One particular class of composite has potential for obtaining optimal polymer composite coatings—polymer clay nanocomposite coatings. Nano-composites generally include one or several types of nano-scale particles dispersed within a polymer matrix. The benefits of some nanoparticles are derived from the very large surface area interactions of the nanoparticles with the polymer matrix, whereas others provide a benefit sue to a non-planar structure. The nature of such interactions allows for beneficial property improvements, sometimes using fillers at very low loading levels, often as low as about 1, and typically about 5 to 10, weight percent. The possibility of using lower loading levels reduces the concerns relative to brittleness often resulting from addition of filler to the coating. The lower loading level also increases the potential for homogeneous dispersion of the filler within the composite matrix. In addition, tubular filler materials have the potential to provide unique properties, such as conductivity (thermal or electrical) and friction (lubrication or tack). Another advantage is the ability to load, store, release or exchange a further component or components from or to the filler particles themselves.

One exciting advance observed through nanocomposite research has been the ability to combine the properties of the polymeric matrix with those of the nanoparticle filler with no negative trade-offs—so that the nanocomposite may be strong while maintaining toughness. The implications of this discovery extend the possibility of creating multifunctional composite protective coatings, which may exhibit some or all of properties such as improved strength, thermal resistance, friction control, and abrasion resistance.

Nanocomposites, and coatings employing nanocomposites, are not exempt from traditional challenges of other well-known composites because the advancement of nanocomposites requires both matrix/filler compatibility and the effective dispersion of filler within the formulation. If either of these requirements is not achieved, the properties of the nanocomposite coating will suffer, and may become less effective than the corresponding unfilled coating composition. Therefore, much of the work surrounding nanocomposites is directed toward attaining homogenous mixtures and finding ways to assure the filler is functionalized to interact with the matrix.

A significant portion of the nanocomposite materials on the market today are based upon nanoclay fillers. In general nanoclay fillers consist of platy or laminar clays, some of which are naturally occurring (e.g., kaolin and smectite), or synthetic clays (e.g., fluorohectorite and fluoromica). Each of the nanoclays is a layered silicate, held together by an intercalation layer—often containing water. In some of the disclosed embodiments, the nanocomposite filler consists of “exfoliated” two-dimensional sheets of clay. In such embodiments, the individual layers are separated from one another and dispersed throughout a polymer matrix. The exfoliation, or separation, process is quite complex and often incomplete, thus frequently leaving larger pieces of clay that create weak points in the polymer matrix. Exfoliation generally involves first swelling the clay by introducing small interacting molecules or polymers into the intercalation space existing between the clay layers, to increase the distance between layers, and finally introducing a shear force or energy to complete the separation of the layers. As many silicates are naturally hydrophilic and many industrially important polymers are hydrophobic, the clay may also be modified or functionalized before mixing the two together while seeking to disperse the filler in the polymer matrix. Otherwise the filler and matrix will likely phase separate rather than form a homogeneous composite. Moreover, organic surface modifiers, used to increase the binding between filler and matrix often adversely affect the properties of the composite. Talc and pyrophyllite, major industrial clays, are quite hydrophobic. However talc and pyrophyllite have been traditionally difficult to delaminate for various reasons, and therefore do not reduce in thickness as well as the naturally swelling, hydrophilic smectite clays. Nonetheless, they can be delaminated to some extent, and therefore do not necessarily need to be surface treated to be compatible with a hydrophobic polymer matrix. Nevertheless, compared with fully exfoliated or delaminated clays, they have much less surface area per gram of clay.

Exfoliation can be quite challenging and expensive, due to the addition of the extra processing step(s). As noted above, even the best processes do not fully exfoliate non-synthetic clay due to intercalated multivalent ions that bind adjacent sheets, crystal defects binding adjacent sheets and other causes. Thus, total de-lamination is rare in natural clays, and un-exfoliated clay may become incorporated into the nanocomposite, causing inhomogeneity and creating weak points throughout the polymer composite matrix. The exfoliation challenge leads to difficulty in obtaining a good dispersion and homogeneous distribution, thereby producing a polymer composite with particles that tend to re-agglomerate and resist separation. A good dispersion means the platy clay, or more specifically the halloysite nanotubes (may be referred to as “HNT” below) are evenly distributed and not clumped or aggregated at the various length scales in the composite (i.e., from the nano-scale to macroscopic-scale). A good dispersion of non-delaminated clay in a polymer is not as desirable as a good dispersion of delaminated platy clay. For HNTs a good dispersion means obtaining very few aggregates of individual HNTs in a polymer matrix.

Traditional protective polymer composite coatings have several potential limitations. First, the addition of filler materials to the protective coating typically strengthens the coating, but may increase the brittleness. In addition, the added filler will likely compromise the optical clarity of the coating, particularly if the filler particles are large.

Typical platy nanoclay-containing protective polymer composite coatings also have potential limitations, as the layers of the platy clay need to be separated, requiring specific chemistry for the intercalation and exfoliation process. If exfoliation is incomplete, the coating will have aggregates, which can lead to failure of the coating and can compromise the optical clarity of the coating. In addition, the need for specific chemistry limits the number of available polymers which will be compatible with the coatings.

The present disclosure addresses the weaknesses in current protective composites coatings while providing additional functionality, or multifunctionality, to these composites that is not currently available with conventional fillers or two-dimensional nanoclay composites. Disclosed embodiments include those directed to polymeric composites including nanotubes and nanoclays, and more particularly those utilizing mineral nanotubes, and a method for preparing such composite protective coatings. The advantages include ease of dispersion, low material and processing costs, and increased coating strength. Furthermore, the use of the nanotubes provides additional functionality via the inner open space or cavity of the tube, sometimes referred to as the “lumen,” particularly the ability to load, store, release or exchange active chemical agents within the tubes, or to coat the tube surfaces. Additionally, the application of other materials to the nanotubes can impart additional properties to a coating in which such nanotubes are used, such as lubricity or electrical conductivity.

Disclosed in embodiments herein is a polymeric nanoparticle coating, comprising: a polymer coating matrix; and a nanotube filler, wherein in combination with said polymer coating matrix said nanotube filler forms the polymeric nanoparticle coating.

Also disclosed in embodiments herein is a method for making a polymer nanocomposite coating, including: producing a milled halloysite having a nanotubular structure; and combining a polymer material with said surface treated halloysite to form the polymer composite.

### BRIEF DESCRIPTION OF THE DRAWINGS

FIG. 1 is a photomicrograph of an exemplary composite coating employing halloysite nanotubes in a latex in accordance with an aspect of the disclosed embodiments;

FIG. 2 is an illustrative representation of the apparatus employed to measure the tackiness of various coatings produced in accordance with the disclosed embodiments;

FIGS. 3A-B includes orthographic views of the apparatus employed to measure the cohesion of various materials produced in accordance with the disclosed embodiments;

FIGS. 4A-B are images illustrating the transparency of an approximately 60 micron thick coating prepared with 10% halloysite nanotube (HNT) filler in latex MG-0580, respectively with and without high shear mixing;

FIGS. 5-9A are graphical representations of testing results as described relative to the embodiments and examples set forth herein;

FIG. 9B is an illustrative example of an coating after completion of the pin on disk test;

FIG. 10A is a graphical representation of pin-on-disk trace results as described relative to the embodiments set forth in Example 2;

FIGS. 10B-10E are illustrative examples of the coating of Example 2 after completion of the pin on disk test;

FIGS. 11A-11D are illustrative examples of a scratch test applied to coatings of Example 2 (samples for 0 (Comparative Ex. 2A), 5, 10, and 20% HNTs in Mowilith LDM 7741S latex.

The various embodiments described herein are not intended to limit the invention to those embodiments described. On the contrary, the intent is to cover all alternatives, modifications, and equivalents as may be included within the spirit and scope of the invention as defined by the appended claims.

### DETAILED DESCRIPTION

A platy clay shall mean a layered or sheet-like inorganic clay material, such as a smectite or kaolin clay, this in the form of a plurality of adjacent bound layers or sheets in a single clay particle, where each layer or sheet has both faces and edges, and where the vast majority of the edges of individual clay layers or sheets decorate the outer surface of the clay particle.

As used herein the term “halloysite” is a naturally occurring clay exhibiting, theoretically, the chemical formula Al₂Si₂O₅(OH)₄.nH₂O (in actuality halloysite may have substitution into the octahedral and tetrahedral sites, such that the formula changes slightly); material that is believed to be the result of hydrothermal alteration or surface weathering of aluminosilicate minerals, such as feldspars. Halloysite in its hydrated form may also be referred to as endellite. Halloysite further includes tubular nanoparticles therein (halloysite nanotubes (HNT)). In alternative embodiments, halloysite may further include synthetic halloysite for example as disclosed in U.S. Pat. No. 4,150,099, hereby incorporated by reference in its entirety, and other non-naturally occurring tubular nanoparticles.

A “nanoparticle composite protective coating” or “nanocomposite protective coating” for short, is intended to include a polymeric composite protective material wherein at least one component comprises an inorganic phase, such as clay (e.g., platy clays, a halloysite material, etc.), with at least one dimension of the inorganic component is in the range of about 0.1 to 500 nanometers.

As more particularly set forth below, the disclosed materials and methods are directed to polymeric composite coatings (e.g., protective coatings), including nanoclay nanocomposite coatings, particularly those utilizing nanotubes (e.g., tubules having at least one dimension in a nano scale along with a large length-to-diameter ratio), and a method for preparing such composites. The advantages include ease of dispersion, low material and processing costs, and increase coating strength without compromising coating clarity. A nanotubular filler eliminates the need for exfoliation as required by other two-dimensional nanoclay fillers and thereby avoids the detrimental properties associated with composites incorporating clay fillers that are not fully delaminated. In other words, the nanotubes are essentially discrete nanoparticles and, therefore, do not require exfoliation to provide the desired dispersion.

Another advantage arises from the additional functionality that is possible with a tubular geometry as opposed to a laminar structure. This functionality is enabled by the inner open space or cavity of the tube, sometimes referred to as a lumen, and particularly the ability to load, release, store or exchange or transport active agents from or to or through the tubes, or to coat the tube surfaces, such as with metal or metal oxides. Latex HNT composites probably include some amount of air therein and for optical applications, it is contemplated that light scattering caused by the presence of air in the cavity may be lowered by filling the tube cavities with a suitable material of a certain refractive index, thereby improving transparency of materials having the HNT filler.

The hollow inner lumen of nanotubes further enables the storage and subsequent release, perhaps controlled release, of active agents. Also contemplated is an additional partitioning of the open space that may permit other possibilities such as protecting incompatibles, allowing fluid transmission, etc. Advantages may also arise simply by virtue of the selective chemistry that occurs in certain tubes, where the inner surfaces have different reactivities, or chemical and physical properties, than the outer surfaces. Additionally, functionality can be imparted through coatings on the tubes themselves that provide thermal conductivity, electrical conductivity, or lubricating properties.

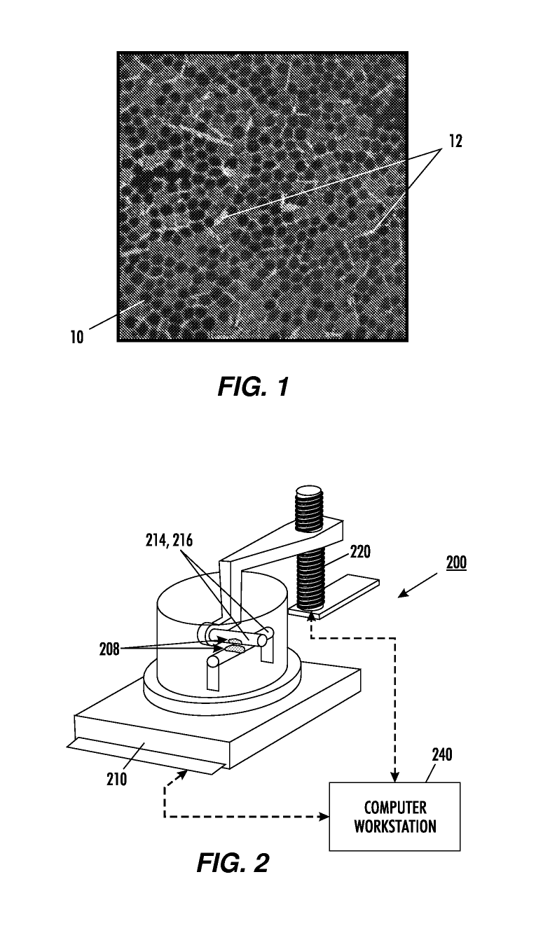

In accordance with an embodiment of the invention, one such mineral nanotube that is naturally occurring is the halloysite nanotube. Referring, for example, to FIG. 1, there is depicted a photomicrograph of a polymeric nanoparticle composite, comprising a latex polymer matrix 10 and a filler including halloysite nanoparticles 12, which resides at the boundaries of the latex particles. The halloysite nanotubes 12 lie at the boundaries of the latex, and also bridge neighboring latex particles. It is further believed that halloysite nanotubes that span many latex particles provide improved mechanical properties to the nanocomposite—that is the high aspect ratio tubes result in improved mechanical performance of the nanocomposite. As described below, the halloysite nanoparticles have a generally tubular or scroll-like shape that is believed to be formed during weathering of a precursor mineral, typically a feldspar. The aluminosilicate weathers to form sheets comprising a bilayer structure with distinct, but covalently linked octahedral (O) and tetrahedral (T) layers, rich in aluminum and silicon, respectively, thus forming a TO-sheet. The hydrated form of the clay consists of bilayer stacks, with apposed bilayers hydrogen bonded via an intercalated water layer. One of the consequences of this bilayer structure is that the octahedral and tetrahedral layers can differ in effective areal charge per metal atom—this difference is believed to cause otherwise planar sheets of halloysite to curl and eventually co-assemble into a scroll-like morphology.

The combination of silica and alumina, in separate tetrahedral and octahedral sheets respectively, further leads to potentially useful characteristics of halloysite an other clays (e.g., imogolite) when in the scroll-like or tubular morphology, characteristics not believed to be seen in either two-dimensional nanoclays or other nanotubes. The fact that the tubes are rolled in one direction means that the inside of the tube has a different surface chemistry when compared to the outside. Such a differential may be useful to perform selective chemistry or to confine or organize chemical agents within the tube, as opposed to on the exterior of the tube, or vice versa. The edges of the HNTs are indeed like the edges of regular clays, so that there will be a pH dependent edge charge that can be useful, but only uniquely so if combined with the hollow nature or the inside/outside surface chemistry differential. For example, at a pH of less than the isoelectric point of the edges (about pH=6), the ends of the tube become positively charged, while the rolled sheet-like basal surfaces remain negatively charged above their isoelectric point (a pH of about 2); in other words above about a pH=2, the aluminosilicate tube walls act as a polyvalent anion, while the ends of the tubes are amphoteric. Differential surface charges below a pH of about 6 can result in a self-organizing network of tubes generally arranged end to wall, at least on a localized level. Differential surface charges also open up an opportunity to do selective chemistry to confine or organize chemical agents within one area of the tube.

Halloysite nanotubes typically range in length from about 100 nm to 10,000 nm (10 microns), with an average (dependent on the natural source) of about 1,200 nm. In one embodiment, the nanocomposite material includes halloysite nanoparticles having a cylindrical length of about 100 nm to about 6,000 nm, with an average of approximately 1,200 nm. Inner diameters of halloysite nanotubes range from about 10 nm up to about 200 nm with an average of approximately 40 nm, while outer diameters range from about 20 nm to about 500 nm with an average of approximately 100 nm. In one embodiment, the nanocomposite material includes halloysite nanoparticles having an average outer cylindrical diameter of less than about 500 nm. It is also possible to characterize the halloysite nanotubes using a relationship between certain dimensions, i.e., an aspect ratio, e.g., length divided by diameter. In one embodiment it is believed that halloysite nanotubes may exhibit a length/diameter ratio of between about 0.2 and 250, with an average aspect ratio of about 12.

Native halloysite is a hydrated clay with an intercalated water layer giving a basal spacing of about 10 Å. Subsequent drying of the clay can lead to the dehydrated form of the clay where the intercalated water has been driven off and the basal spacing reduced to 7 Å. Hydrated and dehydrated halloysite can be distinguished through X-ray diffraction. Dehydration is a naturally irreversible process, though researchers have had some success with artificially rehydrating the tubes with a potassium acetate treatment. In the hydrated form the intercalated water can be substituted out for small cations including organics such as glycerol.

Halloysite is a useful constituent of nanocomposite protective coatings for the purpose of mechanical, physical and thermal property improvement. Nanocomposites including halloysite nanotubes may also be used in embodiments where the filler is surface modified, including where the filler is coated for functionality (e.g., metal coating). In such an embodiment, the coated HNT filler may be used for conductive coatings and shielding, for example. Additionally, a coating could be provided that modifies the frictional characteristics, for example, for lubrication of a mechanical part.

Alternatively, as described herein the nanotubular filler may itself also be filled with an agent for elution (e.g. minerals, light emitting substances such as fluorescent or phosphorescent substances, colorants, antioxidants, emulsifiers, biocides, antifungal agents, pesticides, fragrances, dyes, optical brighteners, fire retardants, self-healing polymers, lubricants, or mixtures and combinations thereof etc.), as described, for example, in U.S. Pat. No. 5,651,976 by Price et al., which is hereby incorporated by reference in its entirety. Also contemplated is an embodiment where the composite filler, for example, HNT, is in turn filled with one or more materials such as colorants, antioxidants, emulsifiers, biocides, antifungal agents, pesticides, fragrances, dyes, optical brighteners, fire retardants, self-healing polymers and plasticizers, or where multiple fillers act in parallel to provide a plurality of properties or advantages including mechanical properties, whiteness, temperature resistance, etc. Although set forth in the disclosed embodiments as exemplary ranges of HNT for particular mechanical properties, the present disclosure further contemplates the use of alternative ranges of HNT being added in order to provide the advantageous affects of one or more eluates or other materials described above.

It shall be further contemplated that adsorption/absorption of agents into the tubes of the filled latex may produce coatings and similar materials suitable for various applications. For example, the filler itself may also be filled with an adsorbent or absorbent substance, for example for removing volatile organics from air, or for fluid uptake. Furthermore the interior of the filler may be surface modified for making the above mentioned elution, or sorption processes more efficient. Further, these tubular fillers may themselves be filled with catalytically active substances or moieties such as enzymes or various non-biologically derived catalysts. In another alternative embodiment, agents such as surfactants and coating aides may be adsorbed or absorbed by the tubes, thus preventing them from migrating to the surface and compromising the surface properties. The migration of surfactants through latex films to a surface is believed to be well-known to those skilled in the art

Although described herein with respect to a particular nanotubular mineral fillers, such as halloysite, it will be appreciated that various alternative materials, both naturally occurring and synthetic, may also be employed. Other inorganic materials that will, under certain conditions, form tubes and other microstructures include other 1:1 sheet silicate clays, such as imogolite, where an effective mismatch in the surface area per charge in apposed tetrahedral and octahedral layers exists. Also included are sulfosalts such as cylindrite and boulangerite. Other materials could include layered double hydroxide materials with an effective mismatch in the area per charge of their respective, apposed octahedral and tetrahedral layers.

The surface of halloysite, particularly the exterior surface of halloysite, or other tubular clay materials may be modified to impart compatibility with the polymer binder, as described in U.S. Pat. No. 6,475,696, which is hereby incorporated by reference in its entirety. In this instance, “compatibility” may be defined as an increased tendency for individual tubes to be well dispersed within the polymer matrix, and or increased tendency for individual tubes to be more adhesively bound with polymers or other components/additives within the matrix. For example, the polymer matrix may contain compatibilizers (e.g., chemicals that strongly interact with halloysite). Alternatively, other components besides the polymer and HNTs could impart compatibilization between the HNTs and polymers.

Dispersion of individual tubes within the polymer matrix is desirable for obtaining uniform properties throughout the polymer-halloysite nanocomposite. Compatibilizers that increase the degree of dispersion of nanotubes within the polymer matrix will therefore increase the homogeneity of physical and or chemical properties within the composite. This is also desirable in many instances as it lowers the cost per unit performance of the nanocomposite. In many cases a compatibilizer that increases the dispersion of tubes in the polymer matrix will also increase the adhesion of the individual tube to components in the polymer matrix.

Adhesion between individual halloysite nanotubes and a polymer matrix (including any other components/additives in the matrix) arises through two distinct mechanisms (or their combination): i) due to net attractive forces acting between the HNT surfaces and the polymer matrix and ii) formation of mechanical interlocking (as in Velcro®). In the first case, the adhesion observed can be from either net attractive physical and/or chemical forces between the surfaces.

Adhesion due to attractive forces between individual halloysite nanotubes and the polymer matrix is governed by the total integrated attractive force between the tube surface and the polymer matrix over the area of contact. Therefore strong bonds and high contact area is one way to achieve a desirably strong adhesion. If the bonds between individual tubes and polymer chains or other components in the matrix are weak, but the contact area (and bond density) high, then suitably high adhesion might also be achieved. Alternatively strong bonds might be sufficient over a smaller contact area. Examples of bonding include: weak bonds such as those acting through London dispersion forces; stronger bonds acting via Keesom forces between permanent dipoles; stronger bonds still are hydrogen bonds. Stronger again are ionic bonds. Stronger bonds again are covalent bonds.

It is, therefore, desirable in some circumstances to add agents that mediate the compatibilization of the tubes in the polymer matrix via the mechanisms mentioned above. The nature of the specific compatibilization agents will vary widely depending on the particular polymer and the particular filler material employed. These compatibilization agents can include inorganic and organic molecules, compounds or other entities, including from biological sources. These can be neutral or ionic. Useful neutral organic molecules may include polar molecules such as amides, esters, lactams, nitriles, ureas, carbamates, diimides, carbodiimides and thiocarbamides. Useful inorganic charged compounds may include carbonates, phosphates, phosphonates, sulfates, sulfonates, nitro compounds, and the like. Preferred neutral organics can be monomeric, oligomeric, or polymeric. Other useful ionic compounds may include cationic surfactants including -onium species such as ammonium (primary, secondary, tertiary, and quaternary), phosphonium, or sulfonium derivatives of aliphatic, aromatic or arylaliphatic amines, phosphines, and sulfides, which can electrostatically bind to the surfaces of the halloysite nanotube material.

Another class of useful compatibilization agents may include those that are covalently bonded to the surfaces of the inorganic nanotubes such as halloysite. Illustrative of such groups that may be useful in the practice of the disclosed embodiments are organosilane, organozirconate, and organotitanate coupling agents. Organosilanes can function as compatibilizing agents that are highly specific to a selected polymer system. In some embodiments of the invention, the compatibilizing agent will include a moiety which bonds to the surface of the material and will not be reactive with the polymer. The agent may also include a moiety, which may not bond with the nanotube material, but is compatible with the polymer.

Clay particles treated with organosilanes, particularly di-alkoxy and tri-alkoxy silanes, (R1O)₂R2R3Si where R1 is alkyl, benzyl or aryl; R2 is independently either alkyl, benzyl, aryl or R1O; and R3 is alkyl, vinyl, glycidoxyalkyl, alkoxy, alkoxyalkyl, aminoalkyl, thioalkyl, chloroalkyl, methacryloxyalkyl, or acryloxyalkyl; can be particularly useful for producing compatible mixtures of clay with polymers. Representative members of this class include but are not limited to: trimethoxyethylsilane, triethoxyoctylsilane, dimethoxydimethylsilane, dimethoxymethylvinylsilane, triethoxyglycidoxypropylsilane, triethoxymethacryloxypropylsilane, trimethoxyaminopropylsilane, trimethoxymethoxypropylsilane. Disilanes of the same type of structure are also useful, R3(R1O)₂Si—X—Si(R1O)₂R3 where R1 and R3 are as described above and —X— is a linking group such as alkylene. A representative but not limiting example is 1,2bis(triethoxysilyl)ethane. Other organosilane compatibilizers include compounds where trichlorosilyl functionality is used in place the trialkoxysilyl group of the above general formula; Cl₃SiR3, where R3 is defined as above. A representative, non-limiting example is trichlorosilylbutane.

Examples of various types of compatibilizing agents that may be useful for treating clays and other inorganic materials having nanotubular structures are included in, but not limited to, the disclosures of U.S. Pat. Nos. 4,894,411; 5,514,734; 5,747,560; 5,780,376; 6,036,765; and 5,952,093, all of which are hereby incorporated by reference in their entirety for their teachings.

Treatment of a halloysite nanotube clay by the appropriate compatibilizing agents can be accomplished by any known method, such as those discussed in U.S. Pat. Nos. 4,889,885; 5,385,776; 5,747,560; and 6,034,163, which are also hereby incorporated by reference in their entirety. The amount of compatibilizing agent can also vary substantially provided the amount is effective to compatibilize the nanotubes to obtain a desired substantially uniform dispersion. This amount can vary from about 10 millimole/100 g of material to about 1000 millimole/100 g of material.

Similarly, polymeric materials may effectively compatibilize polymer-HNT systems. Specifically, copolymers are often used, in which one type of monomer unit interacts with the HNTs, while the other monomer units interacts with the polymer. For example, polypropylene-maleic anhydride copolymer may be added to a polypropylene-HNT nanocomposite to provide compatibilization of the system. The polypropylene segments are miscible with the polypropylene homopolymer, while the anhydride segments interact with HNT surface, thus improving the homogeneity of the resulting nanocomposite.

Similarly, nanoparticles, inorganic clusters and other materials adhered to the surfaces of individual nanotubes can produce an increased roughness on the surface of the nanotubes that may effectively enhance the compatibility of nanotubes with the polymer matrix.

As noted above, the halloysite or other inorganic nanotubes may be employed as fillers in nanocomposite protective materials using any polymer as the matrix, including thermoplastics, thermosets, elastomers, and the like. Examples include polymers such as polyvinyl chloride, polyvinylidene chloride, polyurethane, acrylic-based polymers, polyester, polystyrene, fluoropolymers, and similar materials generally characterized as thermoplastics. Thermoplastic elastomers vary widely and can include, but are not limited to, polyurethane elastomers, fluoroelastomers, natural rubber, poly(butadiene), ethylene-propylene polymers, and the like. Various polymers may also be utilized, including, but not limited to various matrix thermoplastic resins including polylactones such as poly(pivalolactone), poly(caprolactone), and the like, polyurethanes derived from reaction of diisocyanates such as 1,5-naphthalene diisocyanate, p-phenylene diisocyanate, m-phenylene diisocyanate, 2,4-toluene diisocyanate, 4,4′-diphenylmethane diisocyanate, 3,3′-dimethyl-4,4′diphenyl-methane diisocyanate, 3,3-′dimethyl-4,4′-biphenyl diisocyanate, 4,4′-diphenylisopropylidene diisocyanate, 3,3′-dimethyl-4,4′-diphenyl diisocyanate, 3,3′-dimethyl-4,4′-diphenylmethane diisocyanate, 3,3′-dimethoxy-4,4′-biphenyl diisocyanate, dianisidine diisocyanate, tolidine diisocyanate, hexamethylene diisocyanate, 4,4′-diisocyanatodiphenylmethane and the like; and linear long-chain diols such as poly(tetramethylene adipate), poly(ethylene adipate), poly(1,4-butylene adipate), poly(ethylene succinate), poly(2,3-butylenesuccinate), polyether diols and the like; polycarbonates such as poly(methane bis(4-phenyl)carbonate), poly(1,1-ether bis(4-phenyl)carbonate), poly(diphenylmethane bis(4-phenyl)carbonate), poly(1,1-cyclohexane bis(4-phenyl)carbonate), poly(2,2-bis-(4-hydroxyphenyl)propane)carbonate, and the like; polysulfones, polyether ether ketones; polyamides such as poly(4-amino butyric acid), poly(hexamethylene adipamide), poly(6-aminohexanoic acid), poly(m-xylylene adipamide), poly(p-xylyene sebacamide), poly(2,2,2-trimethyl hexamethylene terephthalamide), poly(metaphenylene isophthalamide) (Nomex), poly(p-phenylene terephthalamide) (Kevlar), and the like; polyesters such as poly(ethylene azelate), poly(ethylene-1,5-naphthalate), poly(ethylene-2,6-naphthalate), poly(1,4-cyclohexane dimethylene terephthalate), poly(ethylene oxybenzoate) (A-Tell), poly(para-hydroxy benzoate) (Ekonol), poly(1,4-cyclohexylidene dimethylene terephthalate) (Kodel) (cis), poly(1,4-cyclohexylidene dimethylene terephthalate) (Kodel) (trans), polyethylene terephthlate, polybutylene terephthalate and the like; poly(arylene oxides) such as poly(2,6-dimethyl-1,4-phenylene oxide), poly(2,6-diphenyl-1,4-phenylene oxide) and the like poly(arylene sulfides) such as poly(phenylene sulfide) and the like; polyetherimides; vinyl polymers and their copolymers such as polyvinyl acetate, polyvinyl alcohol, polyvinyl chloride, polyvinyl butyral, polyvinylidene chloride, ethylene-vinyl acetate copolymers, and the like; polyacrylics, polyacrylate and their copolymers such as polyethyl acrylate, poly(n-butyl acrylate), polymethylmethacrylate, polyethyl methacrylate, poly(n-butyl methacrylate), poly(n-propyl methacrylate), polyacrylamide, polyacrylonitrile, polyacrylic acid, ethylene-acrylic acid copolymers, ethylene-vinyl alcohol copolymers acrylonitrile copolymers, methyl methacrylate-styrene copolymers, ethylene-ethyl acrylate copolymers, methacrylated budadiene-styrene copolymers and the like; polyolefins such as (linear) low and high density poly(ethylene), poly(propylene), chlorinated low density poly(ethylene), poly(4-methyl-1-pentene), poly(ethylene), poly(styrene), and the like; ionomers; poly(epichlorohydrins); poly(urethane) such as the polymerization product of diols such as glycerin, trimethylol-propane, 1,2,6-hexanetriol, sorbitol, pentaerythritol, polyether polyols, polyester polyols and the like with a polyisocyanate such as 2,4-tolylene diisocyanate, 2,6-tolylene diisocyante, 4,4′-diphenylmethane diisocyanate, 1,6-hexamethylene diisocyanate, 4,4′-dicycohexylmethane diisocyanate and the like; and polysulfones such as the reaction product of the sodium salt of 2,2-bis(4-hydroxyphenyl)propane and 4,4′-dichlorodiphenyl sulfone; furan resins such as poly(furan); cellulose ester plastics such as cellulose acetate, cellulose acetate butyrate, cellulose propionate and the like; silicones such as poly(dimethyl siloxane), poly(dimethyl siloxane), poly(dimethyl siloxane co-phenylmethyl siloxane), and the like, protein plastics, polyethers; polyimides; polyvinylidene halides; polycarbonates; polyphenylenesulfides; polytetra-fluoroethylene; polyacetals; polysulfonates; polylactic acid, polhydroxyalkanoates, polyester ionomers; and polyolefin ionomers. Copolymers and/or mixtures of these aforementioned polymers can also be used.

Thermosetting polymers may also be utilized, including, but not limited to various general types including epoxies, polyesters, epoxy-polyester hybrids, phenolics (e.g., Bakelite and other phenol-formaldehyde resins), melamines, silicones, acrylic polymers and urethanes. Preferably, thermosetting polymers could be formed in-situ, through introduction of monomers, followed by curing utilizing heat, ultraviolet radiation, or the like. Also, starch, starch-based polymers and other biopolymers are thermosetting polymers that may be utilized along with epoxidized natural vegetable oils, bioresins, protein based thermosets such as prolamins (e.g., zein or kafirin). For an example of a prolamin thermosets, reference is made to United States Patent Publication 2006/0155012.

Biodegradable polymers may also be utilized for forming biodegradable or partially biodegradable nanocomposite coatings with nanotubes. Included in the range of polymers that may be used are biopolymers such as polysaccharides (e.g. starch), starch derivatives, cellulose, cellulose derivatives, polylactic acid polymers, polyhydroxyalkanoate polymers, polypeptides and proteins such as caseins, gelatin, collagens, mucins, wheat gluten, silk fibroin etc.

Gels may also be utilized in forming lubricious, porous or dimensionally responsive nanocomposite coatings with nanotubes. Included in the range of gels are lipid or organogels (e.g., greases, lubricant gels), sol-gels, xerogels, aerogels, hydrogels, protein hydrogels, polyelectrolye gels, environmentally sensitive gels (e.g thermosensitive, pH sensitive, electroresponsive etc),

Polyacrylic nanocomposite protective coatings have been formed, as will be discussed in detail below relative to some of the examples.

It will be further appreciated that various manufacturing methodologies or techniques can be employed in the formation of materials or goods incorporating the nanocomposite materials described herein. These manufacturing process include, but are not limited to, coating, expandable-bead, foaming (see e.g., U.S. Pat. No. 5,855,818, hereby incorporated by reference), thermoforming, vacuum forming, hand lay-up, filament winding, casting, and forging. It is further contemplated that the coating materials and techniques described herein may be applied to other materials, and in various forms. For instance such coatings could be suitable for application to variously formed shapes, sizes and configurations of goods, including fibers or filaments.

The practice of one or more aspects of the invention are illustrated in more detail in the following non-limiting examples including those in which Halloysite was dispersed into an latex emulsion to produce nanocomposite protective coatings. It will be appreciated that various levels and related ranges of halloysite nanotube fillers may be employed, both approximating and between the various filler levels described herein with respect to the Examples, with results comparable to those described below.

### EXAMPLE 1

Halloysite nanotube material, particularly Halloysite premium EG, was obtained from Nanoclays and Technologies, Inc. The halloysite nanotube material was dispersed into a commercially available low-T_{g} Dow Corning acrylic copolymer latex emulsion (MG-0580) at 5, 10, 15 and 20% HNT loading (weight percent solids). MG-0580 is one of a number of acrylic adhesives, or more specifically aqueous pressure sensitive adhesives, available from Dow Corning.

Preparation of the HNT Dispersion

A DISPERMAT VMA-Getzmann GMBH-D-5226 Reichshof, with a 25 mm disk knife, was used to prepare the halloysite dispersion. The HNT powder was added in small portions to water under stirring at 4000 rpm. When all the powder was added, the blend was left under stirring at 4000 rpm for an additional 10 minutes. The suspension was then placed into a conical flask with connection to vacuum to evacuate the HNTs. Dry content of the suspension was determined by evaporation.

Preparation of Suspensions Containing Latex with Low T_{g} and HNT

Latex MG-0580 (T_{g} −45° C. approx.) was chosen for these experiments. Three suspensions of this type were prepared with 5, 10 and 20% weight percent solids HNTs (5% HNT, 10% HNT and 20% HNT) using the suspension described above. More specifically, the halloysite suspension was mixed with a latex dispersion under mild magnetic stirring.

A Petri dish bottom was covered with silicon treated plastic film. The pure latex and the latex-HNT blends were poured into three Petri dishes with a pipette. The amount of the blend to transfer into a dish was calculated to create an approximately 1.0 mm thick film after drying. The blends were left in the ambient environment for two days and were then put in an oven at 50° C. overnight to further cure the films. After drying, the films were covered by another piece of the silicon treated plastic film to make handling easier.

### COMPARATIVE EXAMPLE 1A

Comparative Example 1A was prepared in a manner consistent with Example 1 above, but without the HNTs added (No Additives).

### COMPARATIVE EXAMPLE 1B

A 40% dispersion of Montmorillonite K10 platy clay in water was mixed using the DISPERSMAT mixer, as in Example 1. MG-0580 latex dispersion was added to the clay dispersion in proportions sufficient for obtaining final dry weights of 1%, 5% and 10% clay in the final latex film. Thick latex films were cast from 1% and 5% formulations (1% Clay, 5% Clay), dried, and tested as in Example 1. The 10% formulation was badly flocculated, so a film was not made of that sample.

### EXAMPLE 2

Latex Mowilith LDM 7741S from Celanese Emulsions was used as a commercial latex. The latex is a copolymer emulsion of acrylic acid and methacrylic acid esters, stabilized with unspecified surfactants. It is supplied as a 46% latex dispersion. The T_{g} of the latex is 28° C. and the mean latex size is about 0.1 micron.

Suspensions of Latex Mowilith were prepared with HNT loadings of 5%, 10%, and 20%, according to the procedures used in Example 1. Films were drawn on glass with a 120 μm applicator, and were immediately placed into an oven at 50° C. over night to be cured.

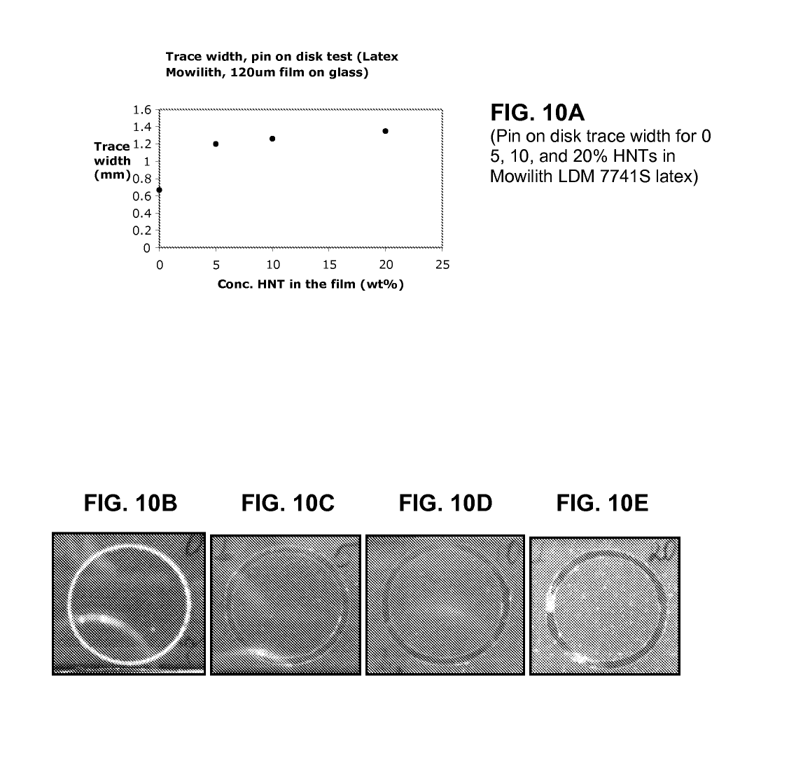

Pin-on-disc measurements were made using the same conditions as in Example 1. Measurement by pin-on-disc are presented in FIGS. 10A-E as described below.

### COMPARATIVE EXAMPLE 2A

Comparative Example 2A was prepared in a manner consistent with Example 2 above, but without the HNTs added (No Additives).

Although the examples set forth above include exemplary means for applying the coatings to a substrate (which may or may not be a permanent application, various techniques and processes may be employed to apply such coatings to various surfaces or substrates, including roller coating (forward and reverse), slide bead coating, slot coating, knife or blade metering, free jet coating, rod metering, die coating, bead coating, dip coating, spray coating, casting, non-contact coating (including application via non-contacting printing techniques so as to selectively coat certain areas of a substrate and not others), screen printing, curtain coating, solid-film coating, metered film press coating, air knife coating, gravure coating and powder coating. As noted such processes may be used to coat entire surfaces or may be selectively applied and/or masked so as to control the application of the coating to a portion of a surface or substrate.

Rheology Measurements

To measure viscoelastic properties G′ (storage modulus) and G″ (loss modulus), a Rheometer CS10 Bohlin was used. The measurements were done in oscillation mode with the following parameters: stress 1000 Pa and frequency from 0.001 to 10 Hz. The measurement system was Plate-Plate (serrated), 25 mm in diameter and 1 mm gap. Every film sample was cut with scissors as a circle (the same size as upper plate), placed on the bottom plate, and pressed to bridge the approximately 1.0 mm gap.

Tackiness Method

The device 200 was used to measure the tackiness between “adhesive” 208 placed on two glass rods is shown in FIG. 2. The readings were recorded on the balance or similar load cell 210, which is connected to a computer 240. Before applying the adhesive, the glass rods 214, 216 (actually small glass tubes) were washed with tap water and then with Milli-Q water. They were then washed with ethanol and dried in a heated oven at 100° C. Polyethylene (Parafilm “M”) and glass rods were used in the experiments and they were prepared in the same manner as the glass. The raw data was obtained by first bringing the surfaces in contact, (glass rods 214, 216 oriented generally perpendicular to one another) using a motorized jack-screw 220 under the control of the computer 240, for example at a linear speed of 0.2 mm/s. When surfaces are in contact there is a positive load exerted on the balance that may be displayed and/or sensed by the computer. The direction is then switched or reversed and the surfaces are pulled apart. The resulting tack force that arises from the adhesion of the rods 214, 216 is then recorded by the computer as a negative reading from the balance (e.g., maximum negative force before separation).

The measurements are repeated on the same sample with increasing positive load—load applied before reversal of the jack-screw 220—and the data are then evaluated by taking the ratio between the tack force and the applied load. In order to reduce the data and to have a standardized comparison, the ratio is extrapolated to a zero applied load by linear regression.

Pin on Disc Measurement

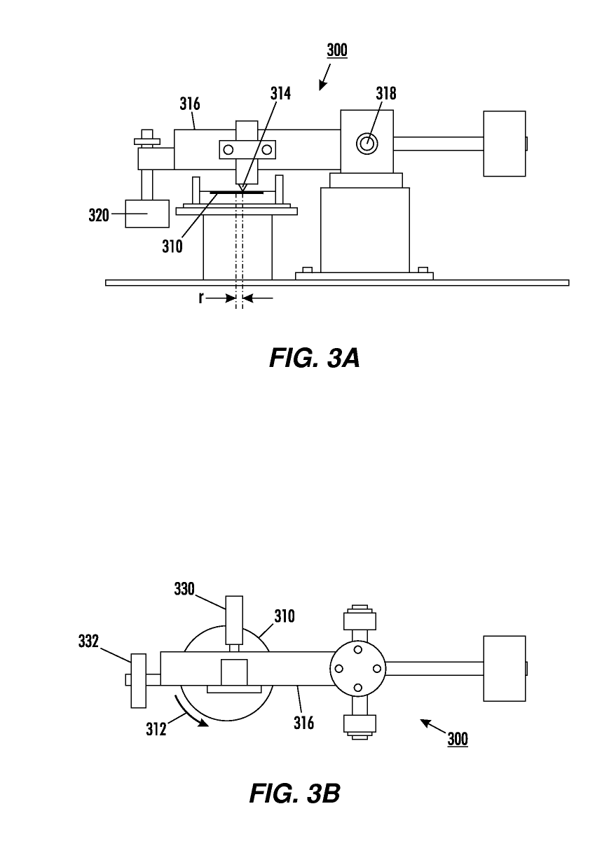

The pin on disc equipment 300, shown in both side and top orthogonal views in FIGS. 3A-B, respectively, was adapted for evaluation of internal cohesion of latex films. The equipment 300 is designed for rotating a disc 310, rotating in the direction of arrow 312 and relative to a fixed, weighted pin or pointed member 314 at a chosen radius (r) from the center of the disc, similar to the manner of the arm of a conventional phonograph with a needle riding on a record. Arm 316 was held in position but allowed to pivot at location 318 so as to permit vertical displacement of the arm's end. In the present experiments the applied vertical load was controlled by a weight or loaded spring 320, and was held constant during the measurement. The tangential force, F, was recorded continuously using one or more transducers 330 and 332. The pin glides on the disc at a radius, r, of approximately 9 mm. The sliding speed, or speed of the disc, as controlled by a drive motor (not shown) was set to 60 rpm. The time for each measurement was 2 minutes and the applied vertical load was 11 N.

Coating Adhesion Measurement

Adhesion of prepared coating samples was measured as follows. The films were tested with a scoring tool having a plurality of parallel sharp wheels (e.g., six wheels). The scoring tool was run across the surface of the coating in a first direction, such that the sharp wheels cut through the film coating to the substrate surface, and then an a second, generally perpendicular direction in the same manner. Pictures of the resulting coating surfaces were taken after scratching with a force applied to said scoring tool, the force being sufficiently large to score through the film to the substrate.

Optical Clarity Evaluation

To assess the optical clarity of the sample coating, a photograph was taken of a traditional slatted fluorescent light source through a glass plate coated with the HNT—low T_{g} latex composite film. The approximately 60 micron thick dry film composition was approximately 10 wt % HNT. The photograph was taken with a hand-held digital camera at a distance of approximately 6-8″ from the coated plate, and approximately 3 feet from the light source.

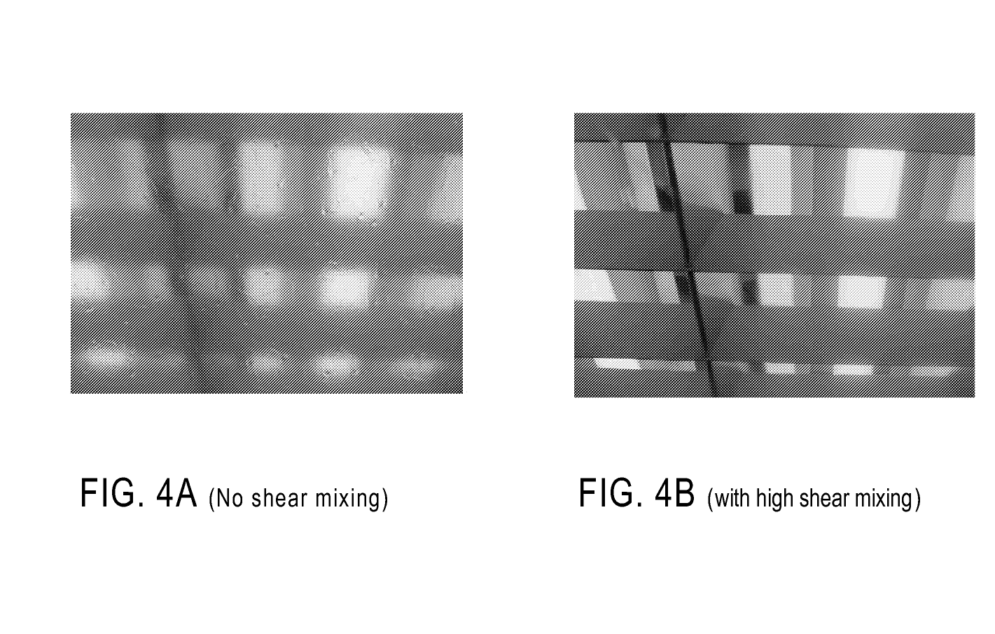

FIGS. 4A and 4B were generated in the manner described, however, with respect to the actually clarity, some of the lack of focus on FIG. 4A occurred as a result of an automatic focus on the digital camera (focus on the film defects not the light source behind it). As a consequence, although the respective photographs are not suitably compared directly with one another, the reason for the lack of focus is the presence of defects in the presence of defects in the sample which did not undergo shear mixing. It may also be observed that if the camera is employed as a “coarse” grading device for optical clarity, the sample viewed in FIG. 4A contained defects that were detected by the camera whereas the camera's auto-focusing system did not detect such defects in the sample of FIG. 4B. In other words, the optical clarity of the film in FIG. 4B is superior to that of FIG. 4A. Furthermore, FIG. 4B is itself an absolute indication that quite sharp images can be obtained through a coating or film loaded at 10% HNT for a useful film thickness (about 60 microns).

Although not specifically tested, it is also possible to employ bleached or otherwise whitened HNTs, which may impact the optical performance of a coating material produced in accordance with one of the embodiments disclosed herein.

Results

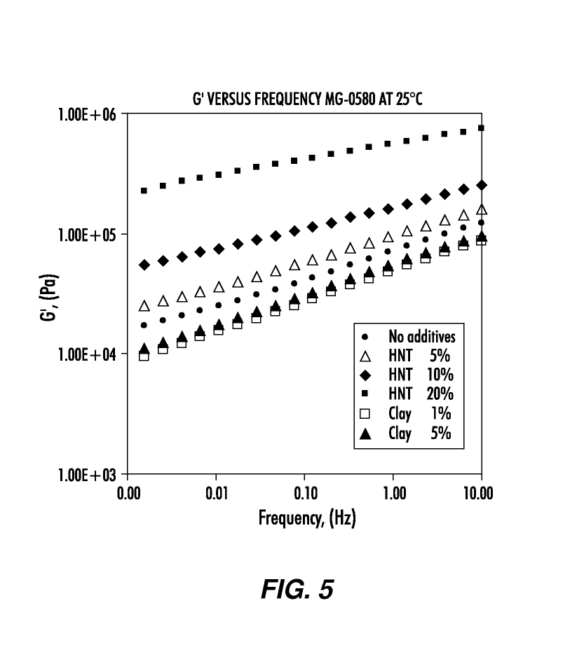

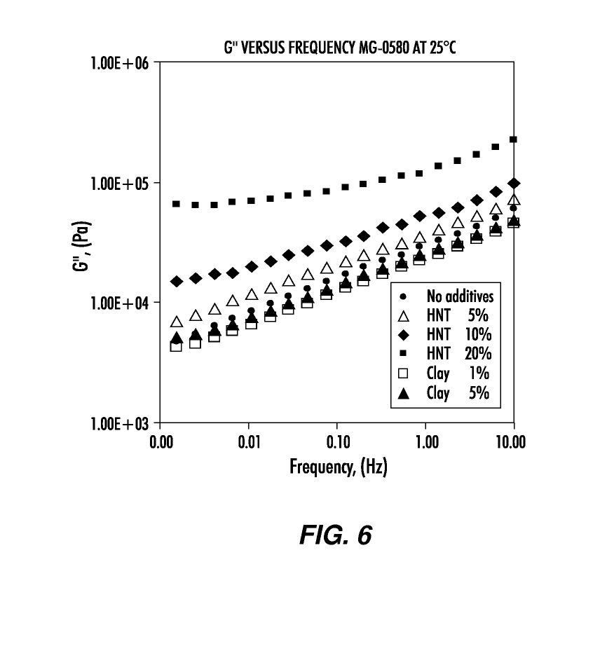

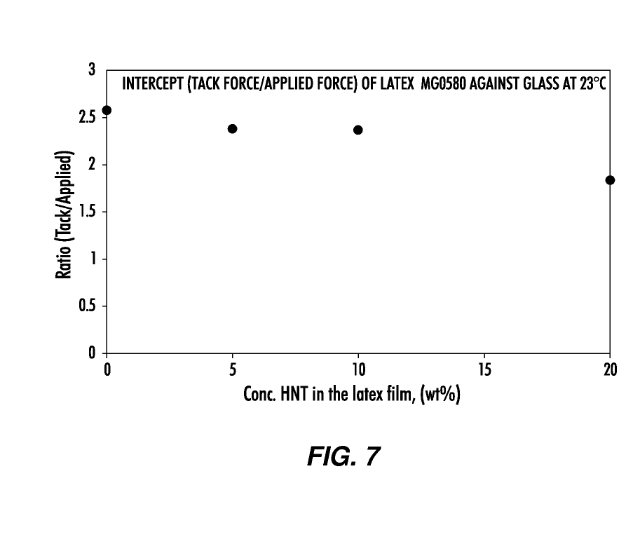

Storage and loss modulus measured using rheometry are presented in FIGS. 5 and 6 and tack and scratch resistance (cohesive strength) results are presented in FIGS. 7-9A. More specifically, FIG. 5 illustrates the measured storage modulus (G′) versus frequency for an MG-0580 latex comparative example, with no HNTs, 1 wt-% and 5 wt-% platy clay added, and with and 5, 10, and 20 wt-% HNT added. FIG. 6 depicts the loss modulus (G″) for an MG-0580 latex comparative example, again versus frequency, using the same material compositions as in FIG. 4.

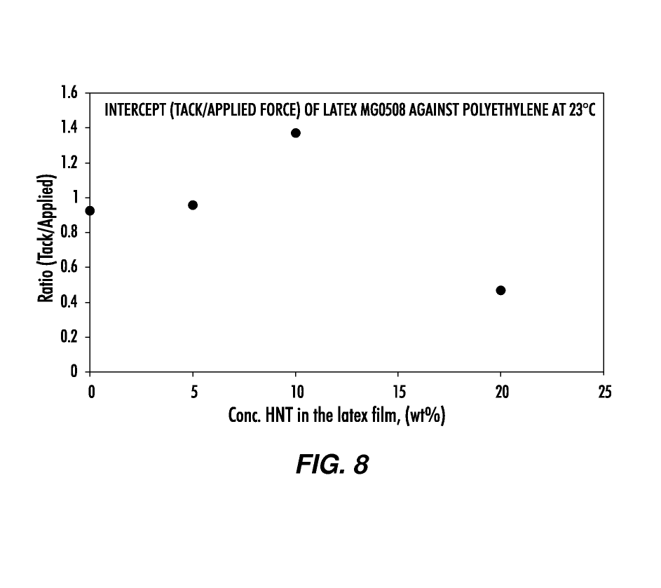

The results of the tack measurement experiments are depicted in FIGS. 7-9A. In FIG. 6, tack measurements are illustrated for 0, 5, 10, and 20 wt-% HNTs in MG-0580 against glass. FIG. 8 illustrates tack measurements for 0, 5, 10, and 20 wt-% HNTs in MG-0580 against Polyethylene (PE).

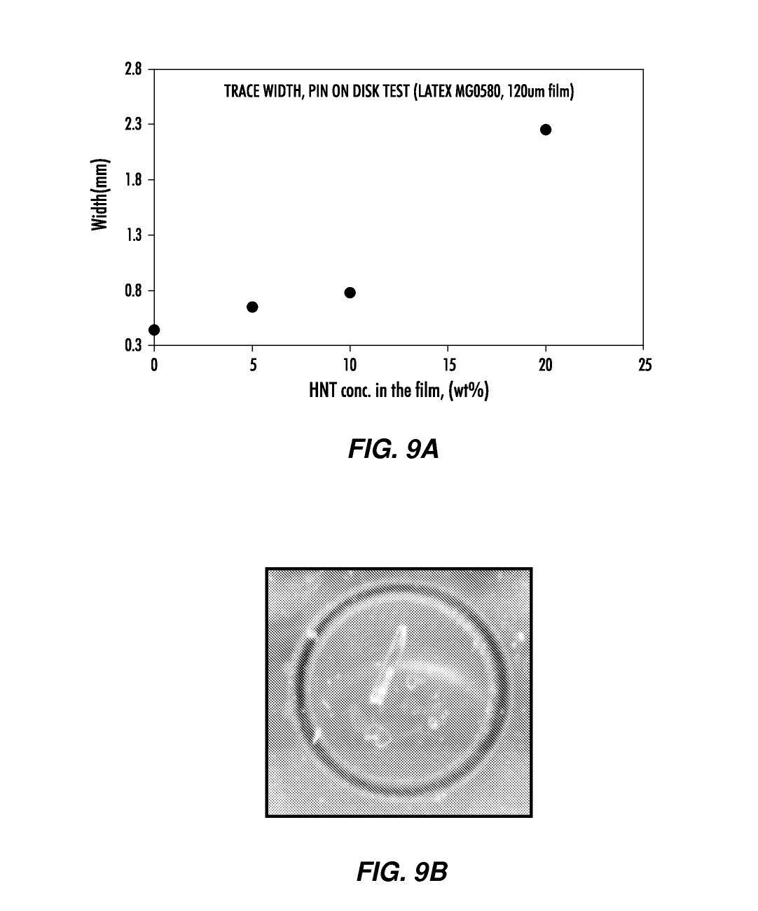

FIG. 9A is an illustration of the test results from various HNT concentrations in the MG-0580 latex composite prepared as described above. More specifically, FIG. 9A illustrates the measurements of the trace width, for example of the sample depicted in the photograph of FIG. 9B, whereby the width of the trace resulting from the pin (314) of FIG. 3A is indicative of an increasing modulus as HNT loading is increased.: The pin-on-disk trace width for 0, 5, 10, and 20% HNTs in MG-0580 is depicted.

FIG. 10A is a graphical illustration of the test results from various HNT concentrations in a Mowilith LDM 7741S latex composite prepared in a manner described above relative to Example 2. More specifically, FIG. 10A illustrates the measurements of the trace width, of the samples depicted in the photograph of FIGS. 10B-10E, respectively, whereby the width of the trace resulting from the pin (314) of FIG. 3A is indicative of an increasing modulus as HNT loading is increased. The pin-on-disk trace width for 0, 5, 10, and 20% HNTs in Mowilith LDM 7741S latex is depicted.

As will be appreciated by an observation of the results depicted in FIGS. 5-10E, increasing the content of the HNTs in the films increased both the elastic or storage (G′) and loss (G″) modulus by an order of magnitude over the HNT range, up to 20 wt-%, relative to comparative example 1 (coating without HNTs) (FIGS. 4 and 5). The results with Comparative Example 1B (platy clay) actually show a reduction in G′ and G″, clearly showing the advantage of the HNT-containing coating. The pin-on-disc measurements (FIGS. 9A-10E) provide evidence consistent with an increasing modulus as HNT loading is increased. Moreover, the data depicted in FIGS. 10A-E indicates that the internal cohesive forces in the HNT loaded films are stronger than in the unloaded latex and also indicates the modulus of the film has increased with increased loading.

Increasing the content of the HNTs in the films increased the both the elastic and loss modulus by an order of magnitude over the frequency range of the rheology measurements. Optical observations show that the highly filled coatings are transparent. (FIG. 2). The pin-on disc measurements provide evidence consistent with increasing modulus with HNT loading.

As is clear from FIG. 1, HNTs were well dispersed within the films, with individual and small clusters of HNTs observed to be scattered along the domains of the individual latex particles.

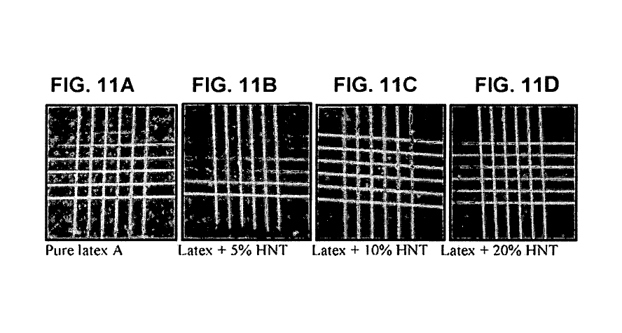

Referring to FIGS. 11A-D, the results of coating adhesion testing described above are depicted. More specifically, FIGS. 11A-D show, respectively, the samples for 0 (Comparative Ex. 2A), 5, 10, and 20% HNTs in Mowilith LDM 7741S latex. The results show that no additional material was removed, indicating that the adhesion is good and addition of HNTs to the coating does not reduce the adhesion up to at least about the 20% HNT level tested.

The amount of nanotubular filler dispersed in the polymer composition, based on the total weight of polymer, is believed to be preferably between about 5 and 30 percent, and more preferably between about 10 percent and about 20 percent —the nanoclay filler including halloysite or similar mineral nanotubes having an outer cylindrical diameter of less than about 500 nm and a length of less than about 40,000 nm (40 um).

As a result of the testing set forth in the Examples and Comparative Examples, it is clear that the introduction of between about 5 to about 20 weight-percent, or about 10 to about 20 weight-percent of a filler consisting essentially of halloysite clay nanotubes (which may or may not be treated) produces an increase in the modulus of the nanocomposite coating. In addition, scratch resistance increases and the coatings are observed to be optically clear (e.g., FIG. 4B).

In embodiments of the present invention it is further contemplated that the halloysite or other inorganic tubular materials may be treated with and/or may include one or more active agents (coated thereon or encapsulated or otherwise present within the interior of the tubular structure). With respect to the treatment, or more particularly surface treatment, it is contemplated that halloysite nanotubes, for example, may be treated using one of the compatibilization agents disclosed herein (e.g. organosilanes). Also contemplated in various embodiments is the surface modification of the halloysite material by exposing the material to benzalkonium chloride in the range of about 0.1 percent to about 2.0 percent, and perhaps more preferably about 0.5 percent to about 1.0 percent. As noted with respect to the results of Example 1, the compatibilization agents are anticipated to provide even greater improvements in the mechanical properties of the nanocomposites in which they are employed. An alternative group of agents, or active agents, are intended to provide a desired effect as a result of their use or delivery using the nanotubes.

Compositions of the invention may include one or more additives or active agents. Those skilled in the art will, with the benefit of this disclosure, recognize that a number of additives may be useful in an embodiment of the present invention. Additives may, for example, include one or more colorants, antioxidants, emulsifiers, biocides, antifungal agents, pesticides, fragrances, dyes, optical brighteners, flame and fire retardants, self-healing polymers and plasticizers (e.g. as described in Provisional Application 60/728,939 previously incorporated by reference) or mixtures and combinations thereof. The amount of the additive necessary will vary based upon the type of additive and the desired effect.

The ratio of the active agent to inorganic (mineral-derived) nanotubular filler may be varied to provide differing levels of efficacy, release profile, and distribution. For example, the compositions may include an approximate ratio of active agent to nanotubular material (by weight) of between 1:1 and 5:1, however ratios in the range of about 1×10⁻⁵:1 to about 10:1 may provide the desired effect.

In some embodiments tubular filler materials have the potential to provide unique properties, such as conductivity (thermal or electrical) and friction (lubrication or tack). Another advantage is the ability to either load, store, release, exchange or transport a further component or components (e.g., chemical agents, fluids, etc.) from or to the filler particles themselves. In one contemplated embodiment, compositions of the invention may provide an active agent or a plurality of active agents in an extended release profile and/or a controlled release profile. For example, the active agent may provide the desired effect in the nanocomposite for weeks, months or even years. It is understood that the release rate may be a function of the solubility of the active agent in its carrier or the composite matrix and/or the mobility/diffusion thereof within the composite. For example, an adherent barrier coating may be employed for retarding or controlling the release rate. Moreover, it is contemplated that a plurality of active agents may be included in a combination of extended and controlled release profiles to achieve a single or perhaps multiple effects. In addition, compositions of the invention may be blended to enhance active agent properties.

In yet an additional embodiment, compositions and methods may also be employed to enable the distribution of one or more active agents, including the distribution of agents at one or more rates and/or at one or more times. The composition may include, for example, mineral-based nanotubular material having one or more active agents and additives. The active agents may be selected from the list of active agents set forth above, or other agents, and combinations thereof. In one example, it is contemplated that an inorganic nanotubular composition may be created to distribute one active agent at a first rate and a second active agent at a second rate, and more particularly, where the first rate is greater than the second rate. As will be appreciated, the foregoing embodiments are intended to be exemplary and are not intended to limit the various embodiments described herein or otherwise incorporating the inventive concepts disclosed.

An embodiment of the present invention may further include the method of encapsulating the active agent within the nanotubular structures of halloysite or similar inorganic materials. In the embodiment, as disclosed for example by Price at al. in U.S. Pat. No. 5,492,696, and hereby incorporated by reference in its entirety, the nanotubes are cylindrical microstructures and may have been pre-treated by metal cladding or coating using an electroless deposition process. Next, the nanotubes are air or freeze dried to provide hollow microcapillary spaces. The micro-capillary spaces are subsequently filled by exposing the dried nanotubes to the active agent and its carrier or solvent, wherein the active agent is allowed to infiltrate (e.g., scattering spreading, injecting, etc.) Post processing of the filled nanotubes may include filtering or other processes to remove the active agent/carrier from the outer surfaces of the nanotubes, or to provide a secondary exposure to permit extended or controlled release of the active agent once the nanotube filler material has been used in the preparation of a nanocomposite material.

As suggested above, the embodiment contemplates the use of a post-infiltration coating that may act as a cap or plug to moderate the release of the active agent. In other words, the polymer composition may further include an adherent barrier coating applied to the nanotubes, for controlling the release of the active agent from the nanotubes. This and other techniques are also disclosed, for example, by Price et al. in U.S. Pat. No. 5,651,976, which is hereby incorporated by reference in its entirety, and where a biodegradeable polymeric carrier is encapsulated within the microcapillary space of the nanotube.

Other possible applications for the use of halloysite nanotubes in a coating nanocomposite include: fire retardant coatings; anti-corrosion coatings; self-cleaning surfaces; self-healing plastics; barrier coatings; optical coatings and paints; biodegradable coatings; anti-microbial coatings; and high temperature coatings. In the foregoing embodiments, the halloysite may be used in crude or refined form. It is further contemplated that while various examples are set forth herein for thermoplastic materials, thermosetting materials and thermoresins may also find particular use with the halloysite nanotubular fillers described herein.

Furthermore, it is contemplated that both water-borne and non-water borne coatings may be produced using the materials and techniques disclosed herein. In the waterborne coatings the HNTs can either be in the water phase or in the polymer phase. If they are dispersed in the water phase then it may be preferable that they are hydrophilic. If they are in the polymer phase then the HNTs may be surface modified to be compatible with the polymeric matrix. As water-borne coatings, for example, the coatings may be employed as paper coatings. The advantage of such coatings, regardless of the manner of application, could be for release uptake, brightening, printing, and at the same time lowering the amount of latex.

As used herein the term crude form halloysite refers to halloysite that is substantially unrefined (e.g., halloysite ore, with little or no further processing or refinement of the halloysite, per se). On the other hand, refined halloysite refers to processed halloysite where the nanotube content has been artificially increased by any of a number of processing and separation technologies. High nanotube content refined halloysite is particularly useful in the foregoing applications in view of its high strength to weight ratio (e.g., for structural reinforcement and for high loading capacity). As illustrated in the examples above, use of the halloysite nanotubes as a filler in the nanocomposite material provides, based upon performance of known clay fillers, improved resistance to thermal decomposition while maintaining or improving the mechanical properties of the composite as compared to the raw polymer.

Furthermore, the surface area within the nanotubes permits slow and consistent dissolution or elution of materials loaded or stored within the nanotube. This feature of the nanotube permits the fabrication of materials having surprising endurance and long life even under extremely harsh conditions (e.g., high temperature, high moisture, low and/or high pressure, high and/or low pH, etc.).

Other possible applications of the disclosed materials and methods are achieved through the compositing of HNTs with other composite coatings and/or adhesives. For example, a material containing HNT may be composited further with carbon fiber/epoxy resins, etc. or with glass fiber/glues. In these composited materials, it is believed that because the halloysite is operative at a nano-micron scale and the carbon or glass fiber is operative at longer length scales, there may be significant combined advantages achieved. As one example, the carbon or glass fiber material may obtain the added characteristics and advantages arising from the use hollow HNTs, as described herein, where the HNTs may release resin curing accelerators, flattening agents, etc. Such embodiments may not only improve the characteristics of the composited material, but may also make it possible to achieve improved applicability.

Further contemplated by the embodiments disclosed herein are coatings made by or with fibers, and more particularly fibers that are manufactured, for example spun, with HNTs. One such example may be nylon/HNT fibers, wovens or non-wovens that are composited into coatings or adhesives.

Although several of the disclosed embodiments are directed to halloysite nanotubes and related clay materials, various aspects and features of the disclosed embodiments may also be achieved with alternative filler materials, some of which also exhibit similar tubular structures, and such materials are also contemplated as alternatives herein. Examples of the alternative nanotubular fillers include: other tubular 1:1 sheet silicates, and particularly those having effective area mismatches per charge in apposed octahedral and tetrahedral layers (e.g., other than halloysite); tubular double-layer hydroxides with effective area mismatches per charge in apposed octahedral and tetrahedral layers; metal sulfides, selenides and tellurides that can form tubes including, but not limited to, MoS2, WS2, TaS2, NbS2, ReS2, etc.; surfactant templated silica nanotubes; metal silicate nanotubes; metal aluminosilicate nanotubes; metal germanate nanotubes; sulfosalts such as cylindrite and boulangerite; metal oxide and hydroxides, including those with a tubular shape; boron-containing nanotubes such as BCN and boron nitride; and organic nanotubes.

It will be appreciated that various of the above-disclosed embodiments and other features, applications and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. A polymeric nanoparticle coating, comprising:
a polymer coating; and
a nanotube filler, wherein in combination with said polymer coating said nanotube filler forms the polymeric nanoparticle coating.

2. The coating of claim 1, wherein the nanotube filler includes halloysite nanoparticles.

3. The coating of claim 2, wherein said halloysite nanoparticles have a generally tubular shape.

4. The coating of claim 1, wherein said polymer coating includes an acrylic polymer.

5. The coating of claim 1, wherein said polymer coating includes a methacrylic polymer.

6. The coating of claim 1, wherein said polymer coating includes a thermosetting material.

7. The coating of claim 1, wherein said polymer coating is selected from the group consisting of:
epoxies;
epoxy-polyester hybrids;
phenolics;
melamines;
urethanes; and
copolymers thereof.

8. The coating of claim 1, wherein said polymer coating includes a thermoplastic material.

9. The coating of claim 1, wherein said polymer coating includes at least one material selected from the group consisting of:
polyesters;
silicones;
acrylic polymers;
methacrylic polymers;
fluoropolymers;
polyurethanes;
and polystyrene;
biopolymers; and
copolymers thereof.

10. The coating of claim 1, wherein said polymer includes a latex polymer.

11. The coating of claim 1, wherein said nanotube filler further includes at least one compatibilization agent.

12. The coating of 11, wherein said compatibilization agent is an organic compound.

13. The coating of claim 11, wherein said compatibilization agent includes an organosilane.

14. The coating of claim 11, wherein said composite exhibits a storage modulus greater than that of said polymer without filler.

15. The coating of claim 11, wherein said polymer consists essentially of latex polymer.

16. The coating of claim 1, wherein said nanotube filler includes halloysite nanoparticles having a generally cylindrical shape and exhibiting differential surface charges to form a localized network of tubes arranged generally end to wall.

17. The coating of claim 3, wherein said nanoparticles include a metal cladding thereon.

18. The coating of claim 1, wherein said nanotubes include at least one agent for elution.

19. The coating of claim 18, wherein said agent for elution is selected from the group consisting of: biocides; minerals; light emitting substances; fluorescent substances; phosphorescent substances; colorants; antioxidants; emulsifiers; antifungal agents; pesticides; fragrances; dyes; optical brighteners; fire retardants; self-healing polymers; lubricants, and combinations thereof.

20. The coating of claim 1, wherein the nanotubes are selected from the group consisting of:
imogolite;
cylindrite; and
boulangerite.

21. The coating of claim 1, wherein the nanotubes are selected from the group consisting of:
tubular 1:1 sheet silicates, including those with effective area mismatches per charge in apposed octahedral and tetrahedral layers;
tubular double layer hydroxides, including those with effective area mismatches per charge in apposed octahedral and tetrahedral layers;
tubular metal sulfides;
tubular metal selenides
tubular metal tellurides;
surfactant templated silica nanotubes;
metal silicate nanotubes;
metal aluminosilicate nanotubes;
metal germanate nanotubes;
tubular metal oxide;
tubular metal hydroxides;
boron-containing nanotubes; and
organic nanotubes.

22. The coating of claim 1, wherein said polymer coating includes a gel.

23. A method for making a polymer nanocomposite coating, including:
producing a milled halloysite having a nanotubular structure; and
combining a polymer material with said surface treated halloysite to form the polymer composite.

24. The method of claim 23, where the milled halloysite is produced using an air milling process.

25. The method of claim 23, further including drying said surface treated halloysite.

26. The method of claim 23, further including surface modifying the halloysite.

27. The method of claim 23, further including forming the polymer nanocomposite coating using a process for application of the polymer nanocomposite selected from the group consisting of: roller coating, slide bead coating, slot coating, knife or blade metering, free jet coating, rod metering, die coating, bead coating, dip coating, spray coating, casting, non-contact coating, screen printing, curtain coating, solid-film coating, metered film press coating, air knife coating, gravure coating and powder coating.

28. The method of claim 23, wherein said halloysite material is surface modified by exposure to a compatibilization agent.

29. The method of claim 28, wherein said compatibilization agent includes an organic compound.

30. The method of claim 29, wherein said organic compound is selected from the group consisting of: neutral and ionic compounds.

31. The method of claim 28, wherein said compatibilization agent includes an inorganic compound.

32. The method of claim 31, wherein said inorganic compound is selected from the group consisting of: neutral, ionic and zwitterionic compounds.

33. The method of claim 28, wherein said compatibilization agent is selected from the group consisting of: organosilane; organozirconate; and organotitanate agents.

34. The method of claim 28, further including air milling the surface treated halloysite.

35. The method of claim 23, wherein said halloysite is combined with said polymer to produce a composite including a range of about 1 to about 20 weight-percent halloysite.

36. The method of claim 23, wherein said halloysite is combined with said polymer to produce a composite including a range of about 5 to about 15 weight-percent halloysite.

37. The method of claim 23, wherein said halloysite is combined with said polymer to produce a composite including about 10 weight-percent halloysite.

38. The method of claim 23, further including adding at least one additive selected from the group consisting of: colorants, antioxidants, emulsifiers, biocides, antifungal agents, pesticides, fragrances, dyes, optical brighteners, self-healing polymers and plasticizers, lubricants, and fire retardants.

39. The method of claim 23, further including:
coating the halloysite with a metal;
drying the coated halloysite to provide hollow micro-capillary spaces; and
filling the micro-capillary spaces by exposing the dried halloysite to an active agent and the agent's carrier or solvent.

40. The method of claim 39, wherein coating the halloysite is accomplished using an electroless deposition process.

41. The method of claim 39, further including applying the composite on a surface to provide a conductive coating thereon.

42. The method of claim 23, further including associating aa lubricant with the halloysite.

43. The method of claim 23, further comprising applying said the nanocomposite coating to only a portion of a substrate surface.

44. The method of claim 43, wherein application to the portion of the surface is accomplished using a selective printing technique.
